(19) United States
(12) Patent Application Publication
(10) Pub. No.: US 2024/0167605 A1
(43) Pub. Date: May 23, 2024

(54) CONNECTION ARRANGEMENT

(71) Applicant: TI Automotive Technology Center GmbH, Rastatt (DE)

(72) Inventors: Albert BOECKER, Ettlingen (DE); Thorsten SCHAEFER, Steinfeld (DE); Florian DEIBEL, Sinzheim (DE); Mathieu AUCOUTURIER, Schlitigheim (FR)

(21) Appl. No.: 18/389,098

(22) Filed: Nov. 13, 2023

(30) Foreign Application Priority Data
Nov. 22, 2022 (EP) 22208887.4

(51) Int. Cl. F16L 37/56; F16L 37/248; F16L 55/00

(52) U.S. Cl. CPC F16L 37/565; F16L 37/248; F16L 55/00

(57) ABSTRACT

A connection arrangement for creating a fluid-tight connection of a first pipe arrangement to a second pipe arrangement, wherein the first pipe arrangement and the second pipe arrangement each have at least two channels, comprising a first coupling element allocated to the first pipe arrangement and a second coupling element allocated to the second pipe arrangement, wherein the first coupling element and the second coupling element can be connected to one another by a locking element, wherein the locking element encompasses the channels.

### RELATED APPLICATIONS

The present disclosure is a national phase application of European Application 22208887.4, filed on Nov. 22, 2022, the entire contents of which is incorporated herein by reference.

### FIELD

The present disclosure relates to a connection arrangement for creating a fluid-tight connection of a first pipe arrangement to a second pipe arrangement, wherein the first pipe arrangement and the second pipe arrangement each comprise at least two channels.

### BACKGROUND

Such connection arrangements are often used for the transport of temperature control media in electromobility. Electric vehicle batteries only show an optimal performance within a limited temperature spectrum. Depending on the ambient temperature, it may therefore be necessary to heat or cool the storage batteries. Therefore, the drive unit of an electric vehicle generally has a temperature control circuit with a pipe arrangement through which temperature control media can be fed to the cells of the storage battery in order to temper them within a desired temperature spectrum. Due to installation space limitations, the temperature control unit should be as compact as possible.

Furthermore, it may be necessary to temper, in particular to cool, components of the entire drive unit of electric vehicles. In addition to the storage battery, this includes the power electronics and the electric motor. The charging electronics and the associated plug connections and cables can also be cooled by means of the temperature control unit. This is particularly relevant in the context of fast charging processes.

In addition to the use in a drive unit, there is a further area of application in connection with other vehicle electronics, in particular sensors and on-board computers.

Temperature control media are also used in air conditioning systems. Air conditioning systems, in particular mobile air conditioning systems, comprise a pipe arrangement which enables the transport of temperature control medium between the individual units of the air conditioning system. In mobile air conditioning systems, for example in air conditioning systems used for climate control of the interiors of motor vehicles, the pipe arrangement is a comparatively complex structure and often comprises pipes made of different materials, for example pipes made of metal, pipe sections made of thermoplastic material and pipe sections made of rubber-like material. Although the operating conditions of the pipe sections can be optimally adapted to the respective requirements, the pipe arrangement is cost-intensive, complex to assemble and difficult to recycle. In the present arrangement, mainly water-based temperature control media, for example water-glycol-based coolants, are considered.

In all applications, most of the time, there is a requirement for the pipe arrangement to be particularly compact. Thus, it may be necessary to connect several channels of a pipe arrangement of a first device to channels of a pipe arrangement of a second device, wherein only very little installation space is available. If several channels have to be connected to each other in a confined installation space, the assembly time is extended, and problems arise due to the confined installation space.

### BRIEF SUMMARY

The present disclosure provides a connection arrangement which is compact and easy to assemble.

The connection arrangement according to the disclosure for creating a fluid-tight connection has a first pipe arrangement and a second pipe arrangement, wherein the first pipe arrangement and the second pipe arrangement each have at least two channels, comprising a first coupling element allocated to the first pipe arrangement and a second coupling element allocated to the second pipe arrangement, wherein the first coupling element and the second coupling element can be connected to one another by a locking element, wherein the locking element encompasses the channels.

Accordingly, in the connection arrangement according to the disclosure, only one locking element is provided for connecting the two pipe arrangements. The locking element simultaneously locks several channels of the pipe arrangements. In doing so, the locking element encompasses the channels, resulting in a particularly compact, space-saving connection arrangement. To assemble the connection arrangement, it is only necessary to actuate the locking element while simultaneously coupling several channels of the two pipe arrangements with each other. This shortens the assembly time and assembly errors, for example insufficient or missing connection of individual channels, can be avoided.

At least one coupling element can have a cylindrical outer contour for receiving the locking element. Preferably, the first coupling element and the second coupling element each have a cylindrical outer contour for receiving the locking element. In this embodiment, the locking element can be formed annular, so that the locking element can be manufactured easily and inexpensively. The cylindrical outer contour also allows the locking element to rotatably encompass the coupling elements, which makes it particularly easy to lock the coupling elements with the locking element.

The locking element can be formed as a retaining ring. This makes the locking element particularly easy and inexpensive to manufacture. In particular, it is conceivable to form the locking element from plastic, for example from an injection-moldable plastic.

Locking contours can be assigned to the outer contour of the first coupling element and/or second coupling element, the locking contours being arranged to engage in locking means of the locking element. This allows the locking element to fix both coupling elements firmly to each other, so that both pipe arrangements are fixed to each other in a loss-proof manner. Due to the fact that the locking element encompasses the coupling elements, it is possible to achieve a fixation in a particularly easy manner.

Depending on the design of the connection arrangement, it is conceivable that the locking of the coupling elements by the locking element can take place without tools.

The locking contours can be in form of protrusions and/or recesses which protrude from the outer contour of the coupling elements or project into the outer contour. The locking means of the locking element are preferably formed congruently with the locking contours. Accordingly, the locking means arranged on the inner circumference of the locking element may protrude inwardly beyond the surface or, alternatively, may be in form of recesses. Preferably, the locking contours of the coupling elements project outwardly and the locking means of the locking element project inwardly from the inner circumferential surface.

According to a first embodiment, the locking contours and the locking means can be formed helicoidally. For this purpose, the locking contours and the locking means can be formed in shape of a screw thread in sections and can, for example, be formed in shape of obliquely extending ribs that project from the surfaces of the coupling elements and the locking element. The coupling elements and the locking element are then fixed by a screwing movement of the locking element relative to the coupling elements.

In order to prevent the locking element from being released from the coupling elements unintentionally, latching means can be provided which fix the locking element on the coupling elements. The latching elements can be in form of a pawl, for example. The pawl may comprise a movable tab formed from the locking element and a recess inserted in at least one coupling element. The tab engages in the recesses in the manner of a pawl and blocks a rotational movement of the locking element in opening direction. To release the connection, it is necessary to space the tab from the recess.

The locking contours and the locking means can be formed as a bayonet connection. A bayonet connection is particularly easy to join and has a defined angular range within which the connection between the locking element and coupling elements can be closed or opened. Latching means can be provided to prevent the connection from releasing automatically. For example, it is conceivable that one or more radially inwardly projecting projections are formed from the locking means, which engage in congruent recesses inserted in at least one coupling element. As soon as the latching means engage with each other, the latching process simultaneously signals that the connection between the connecting element and the coupling elements is complete. This simplifies the assembly.

The connection arrangement can be equipped with a device for detecting the connection status. Such a device simplifies quality control because it is possible to detect by simple means when the components of the connection arrangement are firmly and tightly connected to each other. The device can have optical and/or electronic means.

The optical means can be equipped and arranged, so that they can only be detected when the connection arrangement is correctly connected. For this purpose, an optically readable code can be attached to one or both coupling elements, which is concealed and only exposed after connection. This can be realized by a window inserted into the locking element. The optical code can be a QR code or a barcode, so the code can additionally carry product information. Color coding is also conceivable.

The electronic means can be equipped, so that they can only be read out when the connection arrangement is correctly connected. For this purpose, a transponder can be arranged in one or both coupling elements, which is initially shielded and can only be read after connection. A change of state of the transponder after connection is also conceivable. The electronic means may be in form of an RFID chip.

According to a first embodiment, the channels in at least one coupling element can be arranged concentrically in sections. In this embodiment, the channels are nested within one another, wherein one channel can pass centrally through the connection arrangement and other channels can surround the centrally arranged channel on the circumferential side, for example in form of annular channels. This results in a particularly compact connection arrangement.

According to an alternative embodiment, a transition region is formed from the coupling elements, the channels extending side by side in the transition region. For example, it is conceivable that the channels extend inside the transition region in the manner of a pie slice. With this design, leakage can be avoided particularly easily.

In both designs, it is conceivable that channels open into one another in the area of the connection arrangement, for example, it is conceivable that two of three channels are joined in the area of the connection arrangement.

At least one insert can be provided, through which the channels extend in the area of the coupling elements. This makes it possible to design the pipe arrangements in the area of the coupling elements in a particularly simple and inexpensive manner. In particular, it is conceivable that the insert forms a component of the coupling elements, wherein in particular the outer contour with the locking contours can be formed from the insert. The insert can be made up of several parts, in particular two parts, wherein one insert part is assigned to each pipe arrangement. In this case, the sealing connection between the pipe arrangements is made via the insert parts of the insert. The channels, which are complex in shape in the area of the coupling elements, are formed within the insert. The insert is preferably a plastic component and is preferably made of injection-moldable plastic.

The first pipe arrangement and/or the second pipe arrangement can have at least three channels. The design of more than two channels allows for a complex piping structure and an overall compact arrangement.

Seals can be assigned to the coupling elements to seal the channels against each other. This can reduce the risk of internal leakage.

The first pipe arrangement and/or the second pipe arrangement can be in form of a blow-molded part. Accordingly, the first pipe arrangement and the second pipe arrangement are preferably formed from polymeric material. Blow molding allows the production of one-piece pipe arrangements with complex shapes at low cost.

A temperature control circuit for transporting temperature control medium according to the disclosure comprises at least one connection arrangement according to the disclosure. The temperature control circuit is particularly suitable for controlling the temperature of components of an electric vehicle, wherein temperature control medium, for example water, can be fed through the channels to heat or cool components of the vehicle. The particularly compact design of the connection arrangement and the fact that the components of the connection arrangement are made of plastic make it possible to manufacture a particularly lightweight and compact temperature control circuit.

### BRIEF DESCRIPTION OF THE DRAWINGS

Some embodiments of the connection arrangement according to the disclosure are explained in more detail below with reference to the figures. These show, each schematically:

FIG. 1 depicts a connection arrangement in three-dimensional representation;

FIG. 2 depicts the connection arrangement according to FIG. 1 in section;

FIG. 3 depicts the connection arrangement according to FIG. 1 in section;

FIG. 4 depicts the connection arrangement according to FIG. 1 in partially transparent representation;

FIG. 5 depicts the connection arrangement according to FIG. 1 in partial section representation;

FIG. 6 depicts the connection arrangement with helicoidal locking means;

FIG. 7 depicts a locking element for the connection arrangement according to FIG. 6;

FIG. 8 depicts the latching means of the connection arrangement according to FIG. 6 in detail;

FIG. 9 depicts the connection arrangement according to FIG. 6 in the area of the locking element in section in detail;

FIG. 10 depicts a connection arrangement with a bayonet connection;

FIG. 11 depicts a locking element for the connection arrangement according to FIG. 10;

FIG. 12 depicts a latching means of the connection arrangement according to FIG. 10 in detail;

FIG. 13 depicts the connection arrangement according to FIG. 10 in the area of the locking element in section in detail.

### DETAILED DESCRIPTION

The figures show a connection arrangement 1, wherein the connection arrangement 1 forms a part of a temperature control circuit for transporting temperature control medium. Specifically, the connection arrangement 1 is integrated into a temperature control circuit of an electric motor drive of an electric vehicle and guides volume flows of the medium fed into the temperature control circuit to the electric energy storage devices and electric motors as well as to the power electronics.

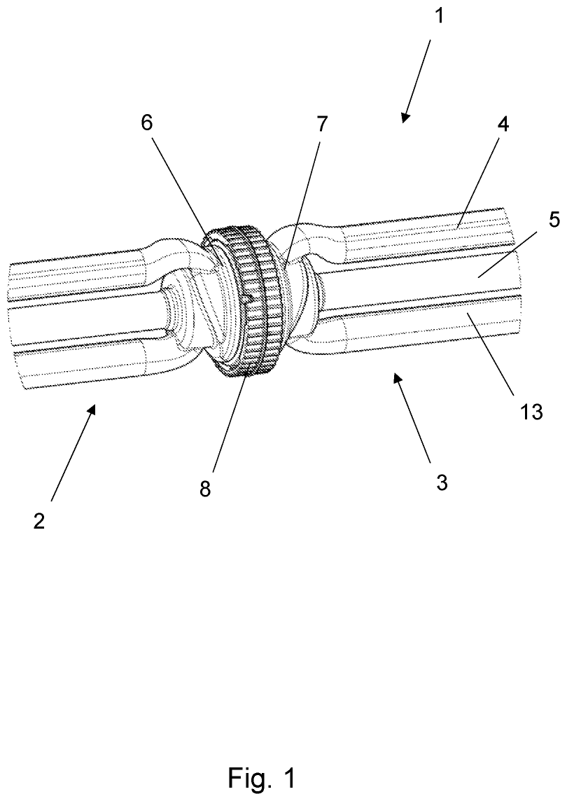

FIG. 1 shows a connection arrangement 1 for creating a fluid-tight connection between a first pipe arrangement 2 and a second pipe arrangement 3. The first pipe arrangement 2 and the second pipe arrangement 3 each have 3 channels 4, 5, 13. A first coupling element 6 is assigned to the first pipe arrangement 2 and a second coupling element 7 is assigned to the second pipe arrangement 3, wherein the channels 4, 5, 13 are arranged concentrically in the area of the coupling elements 6, 7.

According to an alternative embodiment, the channels 4, 5, 13 extend side by side in the area of the coupling elements 6, 7 in a transition region.

The first coupling element 6 and the second coupling element 7 are connected to each other by a locking element 8, wherein the locking element 8 encompasses the channels 4, 5, 13. Both coupling elements 6, 7 have a cylindrical outer contour 9 for receiving the locking element 8. The locking element 8 is designed as a retaining ring.

The connection arrangement 1 is equipped with a device for detecting the connection status. For this purpose, an optically readable element such as optically readable means in the form of a QR code are attached to both coupling elements 6, 7. In this case, the optically readable means can be arranged, so that they can only be detected when the connection arrangement 1 is correctly connected. For this purpose, the means are initially concealed and are only exposed after connection, they then can be seen through a window inserted in the locking element 8.

According to an alternative embodiment, the optically readable means are electronically readable. For this purpose, RFID chips are attached to both coupling elements 6, 7, which can only be read when the connection arrangement is correctly connected.

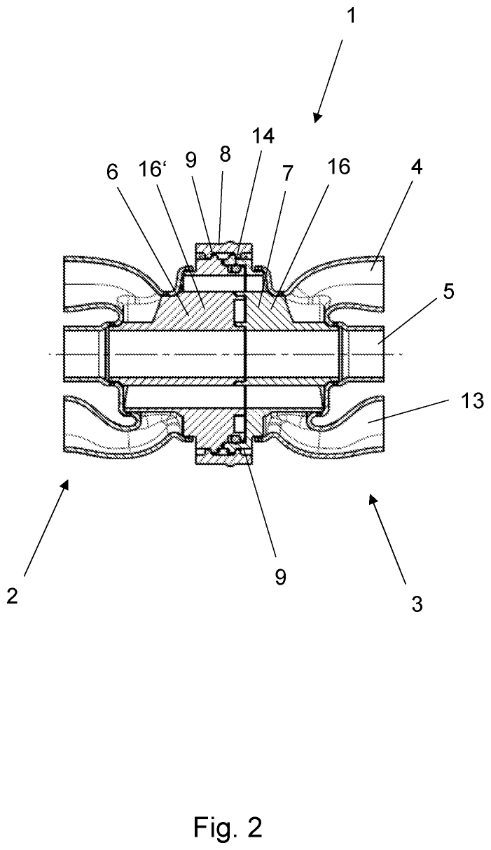

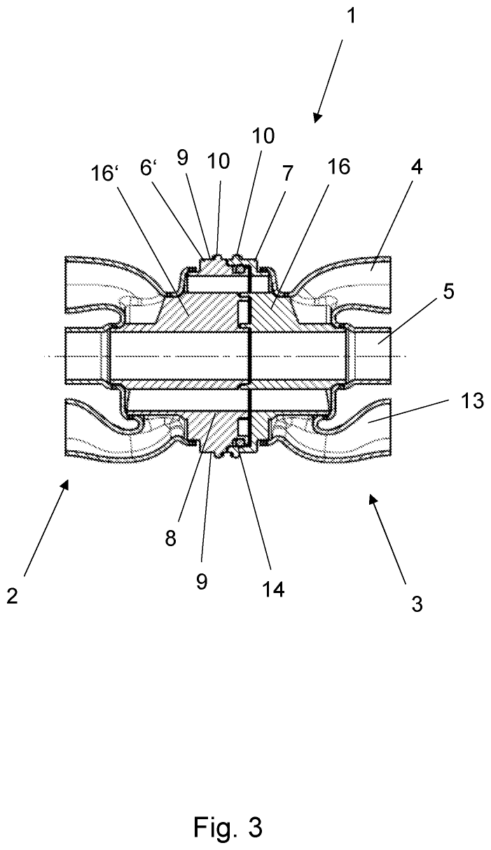

FIGS. 2 and 3 show the connection arrangement 1 shown in FIG. 1 in section. It can be seen that an insert 16 formed in two parts is assigned to the coupling elements 6, 7, wherein the channels 4, 5, 13 extend inside the insert 16. A first insert element 16′ is assigned to the first coupling element 6 and a second insert element 16 is assigned to the second coupling element 7. The two elements of the insert 16 have congruently shaped end faces, wherein seals 14 are provided to seal the channels 4, 5, 13 against each other.

Furthermore, the end faces of the insert elements 16, 16′ have labyrinth structures which further reduce the risk of leakage. In the embodiment shown here, the outer contours 9 for receiving the locking element 8 are formed from the insert 16, so that the insert 16 forms the coupling elements 6, 7 in sections.

Inside the insert 16, the channels 4, 5, 13 extend concentrically. In the transition region to the channels 4, 5, 13 extending in the pipe arrangements 2, 3, inlet contours extending obliquely to the end faces are formed, so that both the insert 16 and the connection arrangement 1 can overall be formed to be particularly compact.

The first pipe arrangement 2 and the second pipe arrangement 3 are formed as a blow-molded part and made of polymeric material. The insert 16 and the locking element 8 are formed as injection-molded parts and also made of polymeric material. The material is preferably chosen from the group of polyamides or polyolefins.

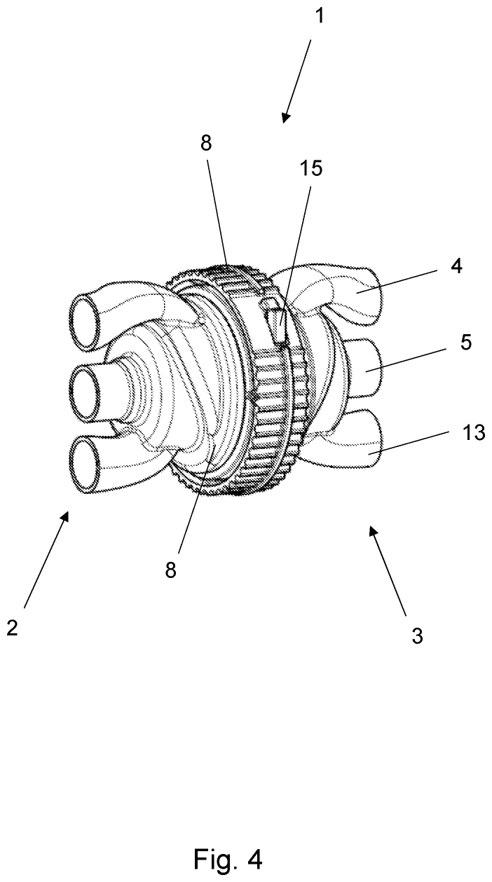

FIG. 4 shows the connection arrangement 1 shown in FIG. 1 in a partially transparent representation. In particular, the latching means or a latch 15 is formed from the locking element 8 can be seen, which prevents automatic release of the locking element from the coupling elements 6, 7.

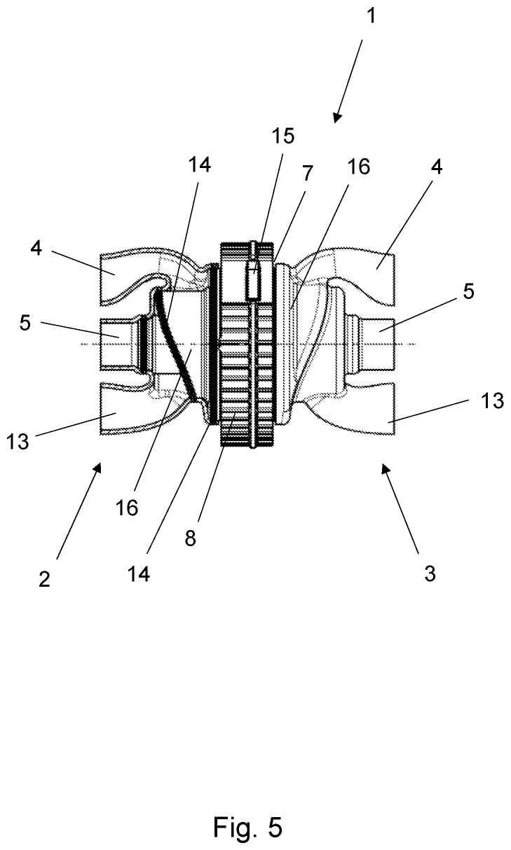

FIG. 5 shows the connection arrangement shown in FIG. 1 in a partial section representation. In particular, the insert 16 and the design of the insert 16 in the transition region between the channel guidance outside the connection arrangement 1 and the channel guidance inside the connection arrangement 1 can be seen. It can be seen that channel 4 flows through the outer annular channel of insert 16, channel 13 flows through the central annular channel, and channel 5 flows through the inner, centrally located, circular channel. The inlet of channel 13 into insert 16 in the direction of the central annular channel is designed obliquely, so that channel 13 can open into the corresponding annular channel parallel to channel 4. As a result, the entire connection arrangement 1 can be formed in a particularly compact manner and, in particular, has only a small longitudinal extent.

Seals 14 can also be seen which are arranged in the mouth area of the insert 16 and seal the insert 16 with respect to the channels 4, 5, 13, thereby preventing internal leakage from occurring. The seals 14 are preferably formed from injection-moldable elastic material, so that the insert 16 can be formed as a two-component injection-molded part, for example.

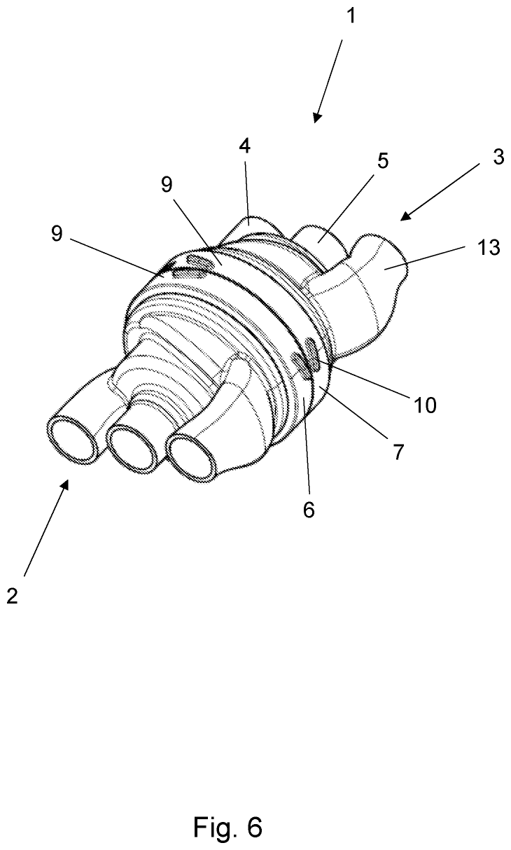

FIG. 6 shows a first embodiment of the connection arrangement 1 shown in FIG. 1. Locking contours 10 are allocated to the outer contour 9 of the first coupling element 6 and the second coupling element 7. These are configured to engage in locking means or a lock 11 of the locking element 8. In the embodiment according to FIG. 6, the locking contours 10 and the locking means 11 are formed helicoidally. For this purpose, rib-like projections are formed from the outer contours 9 of the coupling elements 6, 7, which extend obliquely to the end faces of the coupling elements 6, 7. In the present embodiment, the locking contours of the first coupling element 6 and the second coupling element 7 extend in an arrow-shaped manner towards each other.

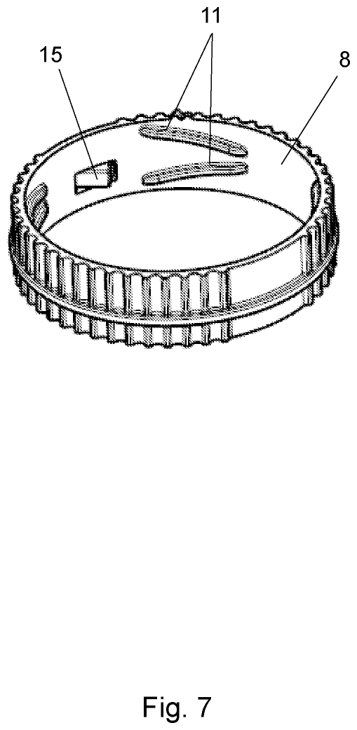

FIG. 7 shows a locking element 8 for the connection arrangement 1 shown in FIG. 6. Here, it can be seen that the locking element 8 has rib-shaped inwardly projecting projections that form the lock or locking means 11, wherein the locking means 11 engage in the locking contours 10. The locking means 11 are also arranged in shape of an arrow. For fixing, the locking element forming a retaining ring is pushed onto the connection arrangement 1 and twisted, so that the locking means 11 engage in the locking contours 10 and fix the coupling elements 6, 7 to each other.

In order to prevent the locking element 8 from being released automatically, latching means 15, 15′ are provided in the locking element 8 and in a coupling element 6. The latching means 15, 15′ comprise a tab hinged to the locking element 8, which engages in form of a pawl in recesses 15′ inserted into the coupling element 6. To release the arrangement, it is necessary to space the tab of the latching means 15 from the recess 15′.

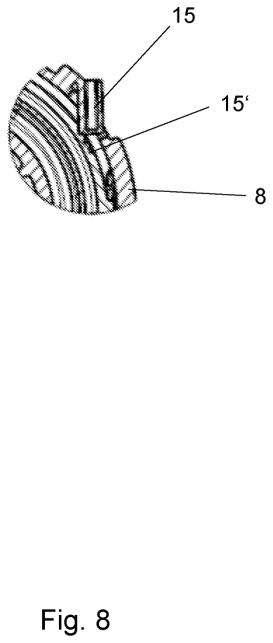

The latching means 15, 15′ is shown in detail in FIG. 8, where it is depicted in section.

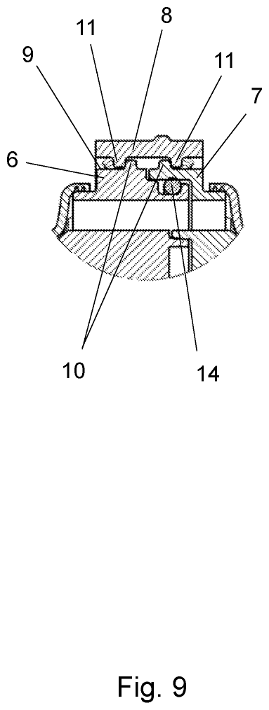

FIG. 9 shows the connection arrangement 1 in the area of the locking element 8 in detail in section.

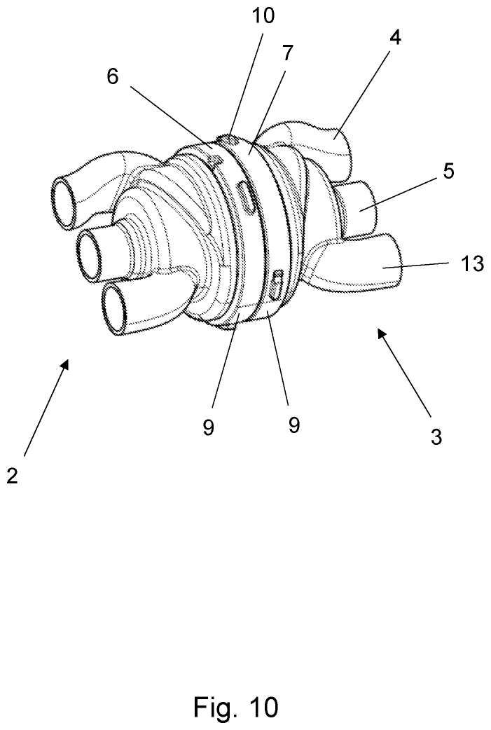

FIG. 10 shows an alternative embodiment of the connection arrangement 1 according to FIG. 1, wherein the locking contours 10 and the locking means or lock 11 are formed as a bayonet connection in this embodiment. For this purpose, projections are formed from the coupling elements 6, 7 and from the locking element 8, which form the locking contours 10 and the locking means 11. To prevent the connection from releasing automatically, this embodiment is also provided with latching means 15. These consist of a projection formed from the locking element 8 projecting radially inwards, which engages in a congruent recess 15′ inserted in a coupling element 6

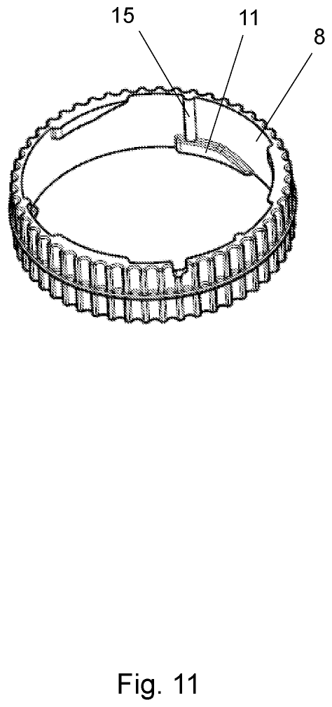

FIG. 11 shows a locking element 8 for the connection arrangement 1 according to FIG. 10.

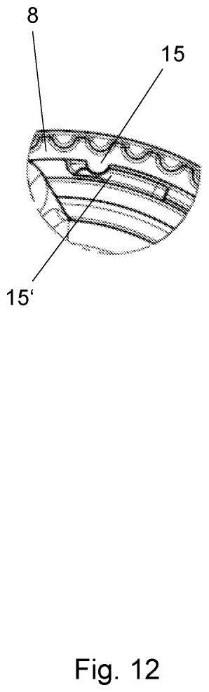

FIG. 12 shows the connection arrangement 1 in the area of the locking element 8 and the latching means 15 according to FIG. 10 in detail.

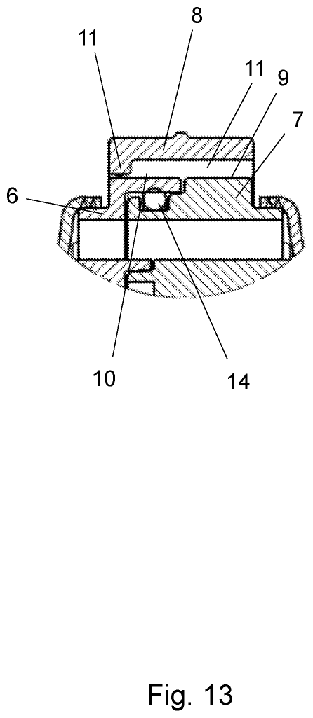

FIG. 13 shows the connection arrangement 1 in section in the area of the locking element 8 in detail.

1. A connection arrangement for creating a fluid-tight connection of a first pipe arrangement to a second pipe arrangement, wherein the first pipe arrangement and the second pipe arrangement each have at least two channels, the connection arrangement comprising a first coupling element allocated to the first pipe arrangement and a second coupling element allocated to the second pipe arrangement, wherein the first coupling element and the second coupling element can be connected to one another by a locking element, wherein the locking element encompasses the channels.

2. The connection arrangement according to claim 1, wherein at least one coupling element has a cylindrical outer contour for receiving the locking element.

3. The connection arrangement according to claim 1, wherein the locking element is formed as a retaining ring.

4. The connection arrangement according to claim 1, wherein locking contours are allocated to the outer contour of the first coupling element and/or the second coupling element, the locking contours being aligned to engage in locking means of the locking element.

5. The connection arrangement according to claim 4, wherein the locking contours and the locking means are formed helicoidally.

6. The connection arrangement according to claim 4, wherein the locking contours and the locking means are formed as a bayonet connection.

7. The connection arrangement according to claim 1, wherein the channels in at least one coupling element are arranged concentrically in sections.

8. The connection arrangement according to claim 1, wherein a transition region is formed from the coupling elements, the channels extending side by side in the transition region.

9. The connection arrangement according to claim 1, wherein at least one insert is provided, through which the channels extend in the area of the coupling elements.

10. The connection arrangement according to claim 1, wherein the first pipe arrangement and/or the second pipe arrangement have at least three channels.

11. The connection arrangement according to claim 1, wherein seals are allocated to the coupling elements, the seals sealing the channels against one another.

12. The connection arrangement according to claim 1, wherein the first pipe arrangement and/or the second pipe arrangement are formed as a blow-molded part.

13. The connection arrangement according to claim 1, wherein the first pipe arrangement, the second pipe arrangement, the first coupling element, the second coupling element and/or the locking element are formed of polymeric material.

14. A temperature control circuit for transporting temperature control medium, comprising a connection arrangement according to claim 1.
